(19) United States
(12) Patent Application Publication
(10) Pub. No.: US 2015/0134798 A1
(43) Pub. Date: May 14, 2015

(54) Standardized Crowd Sourcing

(71) Applicant: AT&T Intellectual Property I, L.P., Atlanta, GA (US)

(72) Inventors: Mostafa Tofighbakhsh, Cupertino, CA (US); Cagatay Buyukkoc, Holmdel, NJ (US); Shyam Parekh, Orinda, CA (US)

(73) Assignee: AT&T Intellectual Property I, L.P., Atlanta, GA (US)

(21) Appl. No.: 14/079,012

(22) Filed: Nov. 13, 2013

(51) Int. Cl. H04L 12/26

(52) U.S. Cl. CPC H04L 43/062
USPC 709/223

(57) ABSTRACT

Crowd sourcing data is translated into a standard crowd sourcing format for crowd sourcing analytics. Mobile devices automatically send reports of standardized crowd sourcing information to a centralized crowd-sourcing server. The centralized crowd-sourcing server aggregates all the reports according to location. Crowd sourcing applications query the centralized crowd-sourcing server to retrieve standardized data for populations of mobile devices sharing the same location. Crowd sourcing analytics may be quickly and inexpensively performed with reduced queries to individual devices.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Crowd sourcing is expected to continue in popularity. Conventional crowd sourcing solicits information from groups of mobile devices to provide some service. Crowd sourcing is used for voting, reporting, and even funding.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-4 are simplified schematics illustrating an environment in which exemplary embodiments may be implemented;

FIGS. 5-10 are schematics illustrating standardized multimedia reporting, according to exemplary embodiments;

FIGS. 11-12 are schematics illustrating standardized commands, according to exemplary embodiments;

FIG. 13 is a schematic illustrating configuration settings, according to exemplary embodiments

FIG. 14 is a schematic illustrating anonymous reporting for crowd sourcing analytics, according to exemplary embodiments;

FIG. 15 is a more detailed schematic illustrating the operating environment, according to exemplary embodiments;

FIGS. 16-17 are diagrams illustrating a crowd sourcing database, according to exemplary embodiments;

FIG. 18 is a diagram illustrating centralized standardization, according to exemplary embodiments;

FIG. 19 is a more detailed block diagram illustrating the operating environment, according to exemplary embodiments;

FIGS. 20-21 are detailed block diagram illustrating crowd-sourcing control of radio networks, according to exemplary embodiments;

FIGS. 22-23 are block diagrams further illustrating a crowd sourcing kernel, according to exemplary embodiments;

FIGS. 24-26 are block diagrams illustrating network resource management, according to exemplary embodiments;

FIGS. 27-30 are more block diagrams illustrating crowd-sourced control of communications networks, according to exemplary embodiments; and

FIGS. 31-32 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

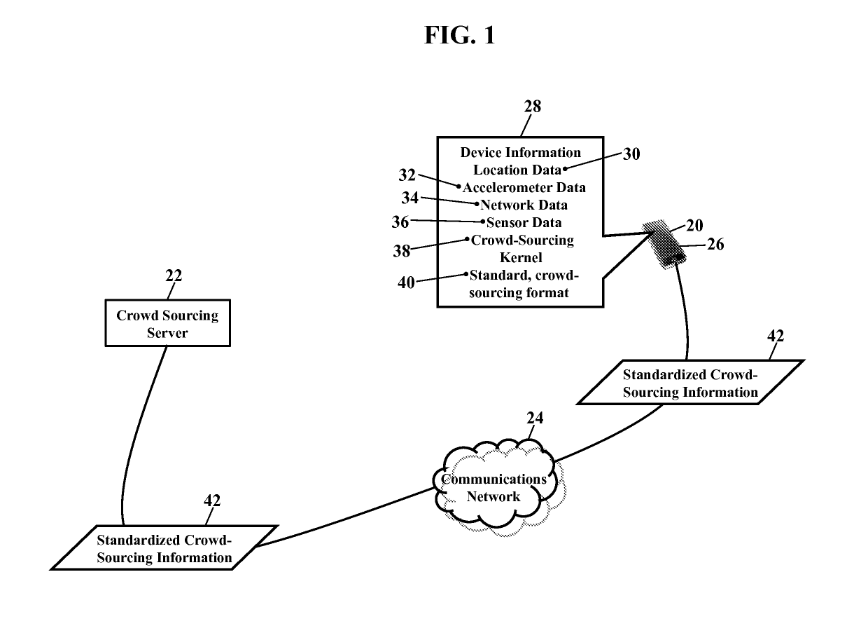

FIGS. 1-4 are simplified schematics illustrating an environment in which exemplary embodiments may be implemented. FIG. 1 illustrates a mobile device 20 that communicates with a crowd-sourcing server 22 using a communications network 24. The mobile device 20, for simplicity, is illustrated as a smart phone 26. The mobile device 20, though, may be any mobile or stationary processor-controlled device (as later paragraphs will explain). As the mobile device operates, the mobile device 20 collects all kinds of device information 28. The mobile device 20, for example, receives location data 30 from a global positioning system (GPS), accelerometer data 32 from an accelerometer, and network data 34 to/from the communications network 24. The mobile device 20 may also collect time, temperature, and any other sensor data 36. Whatever device information 28 is collected, the mobile device 20 processes the device information 28 for crowd sourcing analytics.

The device information 28 is standardized. As FIG. 1 illustrates, the mobile device 20 may call a crowd-sourcing kernel 38 to automatically translate the device information 28 into a standard, crowd-sourcing format 40 for crowd sourcing analytics. That is, the device information 28 is converted to a unified, open format that is commonly recognized by any crowd sourcing application or service. The mobile device 20 thus reports globally understood, standardized crowd sourcing information 42 to the crowd-sourcing server 22. The crowd-sourcing server 22 then makes the standardized crowd sourcing information 42 available to third party applications and vendors for crowd sourcing services. The standardized crowd sourcing information 42 may thus be used to influence behaviors, policies and dynamic adaptations.

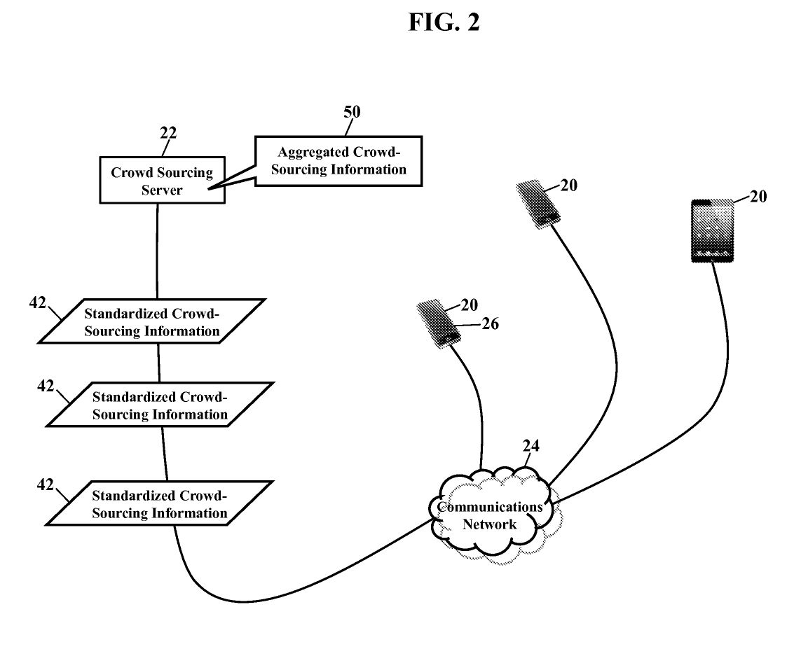

FIG. 2 illustrates aggregation with other users. As the reader likely knows, thousands and even millions of people carry all types of mobile devices 20. Exemplary embodiments permit each user's mobile device 20 to send its respective standardized crowd sourcing information 42 to the crowd-sourcing server 22. FIG. 2, for simplicity, only illustrates a few different mobile devices 20. In practice, though, there may be many mobile devices 20 reporting their respective standardized crowd sourcing information 42 to the crowd-sourcing server 22. Because each mobile device's standardized crowd sourcing information 42 is formatted for global recognition, the crowd-sourcing server 22 may aggregate all the standardized crowd sourcing information 42 from sets or populations of different mobile devices 20. The crowd-sourcing server 22 thus makes aggregated crowd sourcing information 50 available for analysis. Third party applications and vendors, for example, may use the aggregated crowd sourcing information 50 when providing crowd-sourcing services.

Exemplary embodiments thus provide a central solution for crowd-sourcing services. The crowd-sourcing server 22 is a central repository for the standardized crowd sourcing information 42 from populations of the mobile devices 20. Vendors and software applications need not query each individual mobile device 20 for analytic data. The centralized crowd-sourcing server 22 simplifies application development and provides faster processing for behavioral analysis. Moreover, the central location for the standardized crowd sourcing information 42 (and the aggregated crowd sourcing information 50) greatly reduces queries to the mobile devices 20, thus also reducing network congestion.

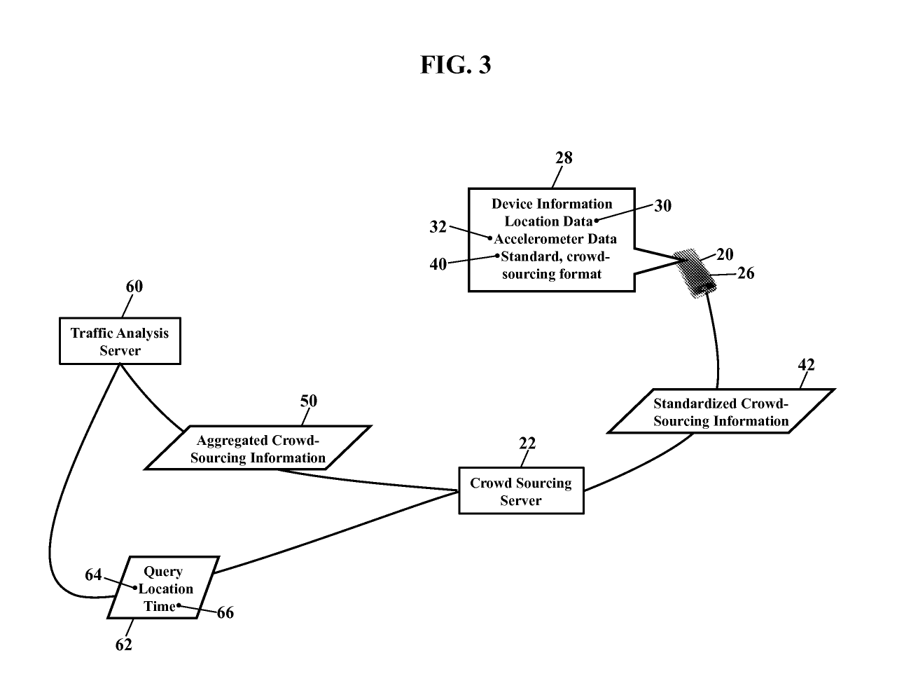

FIG. 3 illustrates device sourcing for traffic analysis. Here exemplary embodiments may be used to monitor traffic congestion. As a user of the mobile device 20 commutes along a freeway, the user's mobile device 20 acquires the device information 28. The mobile device 20, for example, receives or generates its location data 30. The mobile device 20 may use the location data 30 to measure or estimate its speed and/or direction of movement. The mobile device 20 may also receive and interpret the accelerometer data 32 as a measure of stop-and-go activity. Whatever the device information 28, the mobile device 20 translates the device information 28 into the standard, crowd-sourcing format 40. The mobile device 20 then reports the standardized crowd sourcing information 42 to the crowd-sourcing server 22.

The crowd-sourcing server 22 makes the standardized crowd sourcing information 42 available to crowd sourcing services. FIG. 3, for example, illustrates a traffic analysis server 60. The traffic analysis server 60 uses the standardized crowd sourcing information 42 to determine vehicular congestion along roadways. The traffic analysis server 60 sends a query 62 to the crowd-sourcing server 22. The query 62 specifies any query parameter, such as a query location 64 and time 66. The query location 64, for example, may be some name of a road or freeway. The crowd-sourcing server 22 retrieves the aggregated crowd sourcing information 50 that is associated with the query location 64 and the time 66. The crowd-sourcing server 22 responds by sending the aggregated crowd sourcing information 50 to the network address of the traffic analysis server 60. The traffic analysis server 60 then uses the aggregated crowd sourcing information 50 to determine real-time congestion associated with the query location 64.

Here, then, exemplary embodiments may automatically report crowd sourcing data. The mobile device 20 may automatically send the standardized crowd sourcing information 42, without the intervention of the user, to estimate and accurately calculate real-time traffic conditions. Indeed, hundreds or even thousands of other users' mobile devices 20 may similarly report their standardized crowd sourcing information 42, thus generating inexpensive real-time traffic reports. Exemplary embodiments thus utilize the best traffic congestion measurements made by the mobile devices 20 that are already on the road where congestion exists. Real-time traffic information is thus propagated from the crowd-sourcing server 22 to the traffic congestion server 60, where accurate, real time traffic congestion maps may be generated.

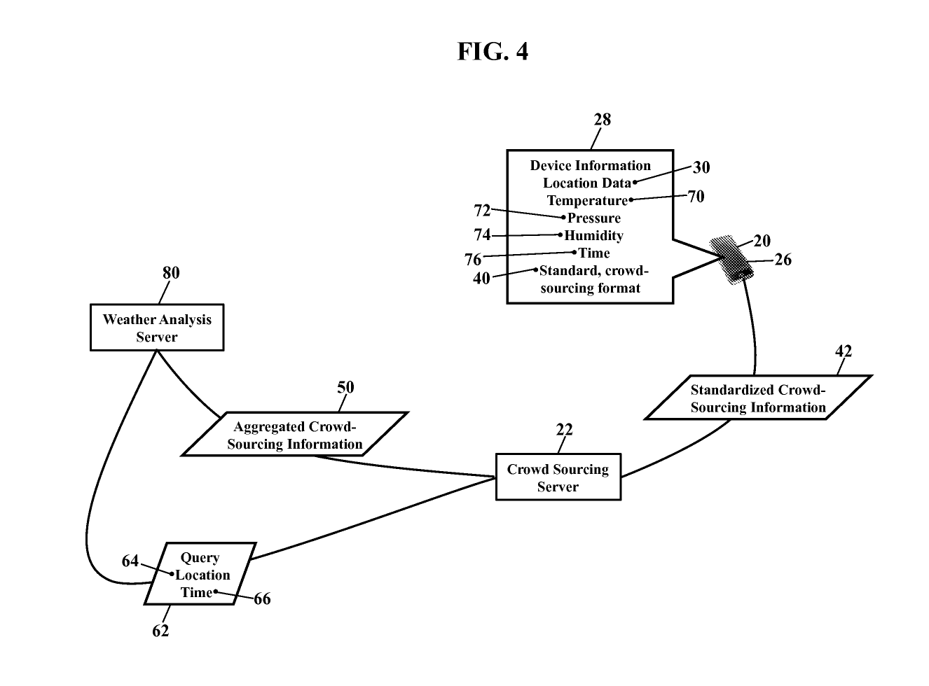

FIG. 4 illustrates device sourcing for weather conditions. Here, individual micro-reports from the mobile devices 20 may be used for weather prediction. When the mobile device 20 is powered and operating, the mobile device 20 collects its location data 30. However, the mobile device 20 may also acquire a current temperature 70, a barometric pressure 72, a humidity 74, and the current time 76 of day. Again, whatever the device information 28, the mobile device 20 translates the device information 28 into the standard, crowd sourcing format 40. The mobile device 20 then reports the standardized crowd sourcing information 42 to the crowd-sourcing server 22.

The crowd-sourcing server 22 makes the standardized crowd sourcing information 42 available to crowd sourcing services. FIG. 4, for example, illustrates a weather analysis server 80 that provides weather-related services. The weather analysis server 80 queries the crowd-sourcing server 22 for the standardized crowd sourcing information 42 associated with the query location 64 and/or the time 66. The weather analysis server 80 retrieves the standardized crowd sourcing information 42 and uses the standardized crowd sourcing information 42 to predict weather conditions. Exemplary embodiments, in other words, may automatically report the standardized crowd sourcing information 42 to predict local, regional, or national weather conditions. Indeed, crowd sourcing of individual micro-reports may be used to measure or predict winds, severe weather, pollen counts, and any other weather conditions. As hundreds or thousands of other users' mobile devices 20 may similarly report their standardized crowd sourcing information 42, weather reporting becomes less inexpensive and more accurate.

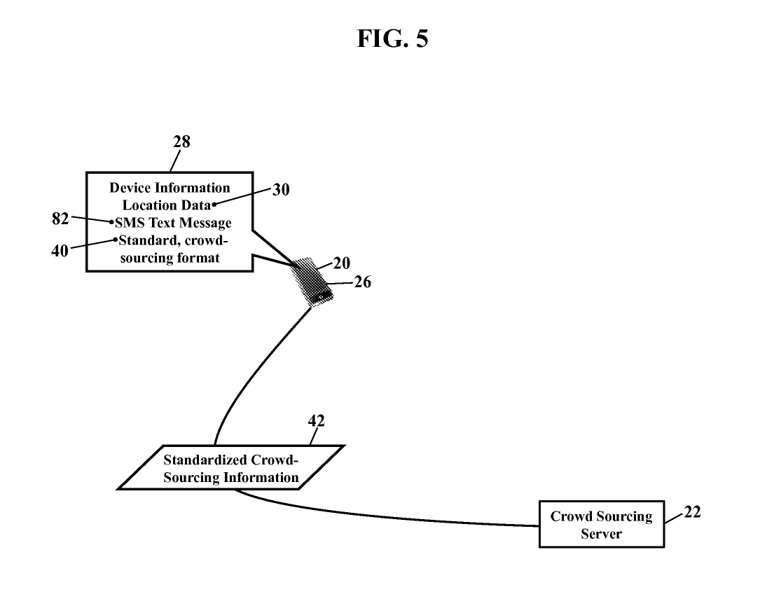

FIGS. 5-10 are schematics illustrating more standardized multimedia reporting, according to exemplary embodiments. Here the mobile device 20 may also standardize and report any multimedia content to the crowd-sourcing server 22. FIG. 5, for example, illustrates a short message service (SMS) text message 82 that is received by, and/or stored in, the mobile device 20. The mobile device 20 may translate the text message 82 into the standard, crowd-sourcing format 40. The mobile device 20 may then report the standardized crowd sourcing information 42 to the crowd-sourcing server 22. The mobile device 20, in other words, converts the user's text messages 82 into the open, globally understood crowd-sourcing format 40 for publication by the crowd-sourcing server 22. Populations of text messages, having the standard, crowd-sourcing format 40, may thus be made available for crowd-sourcing services.

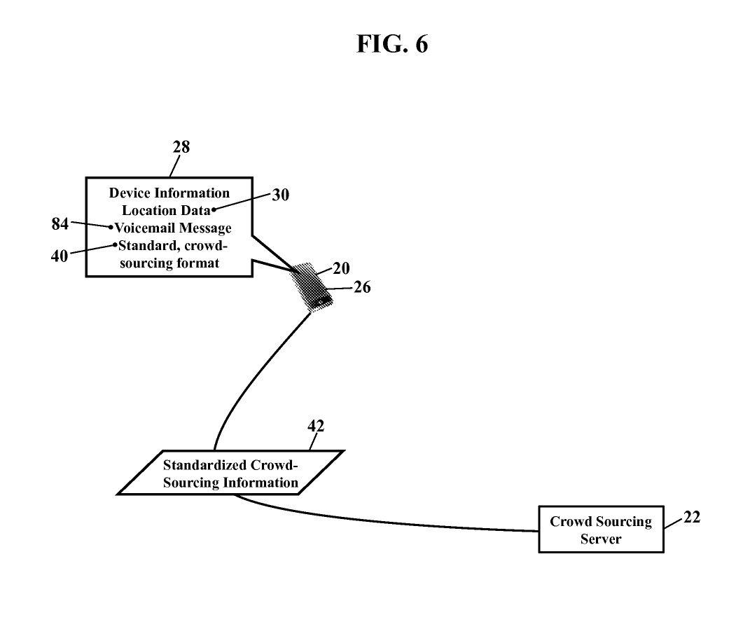

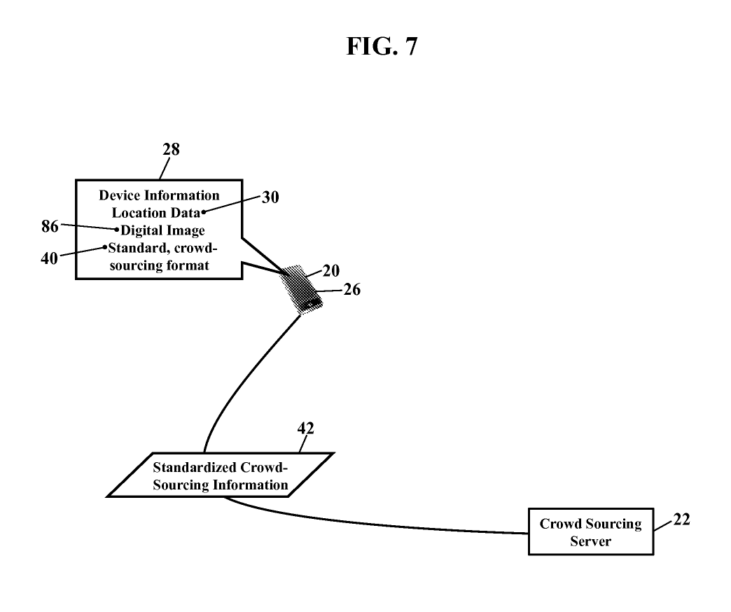

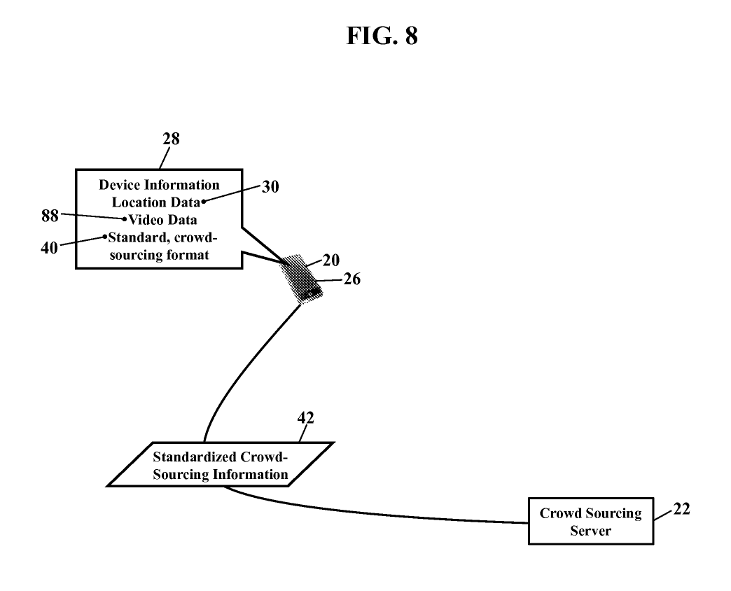

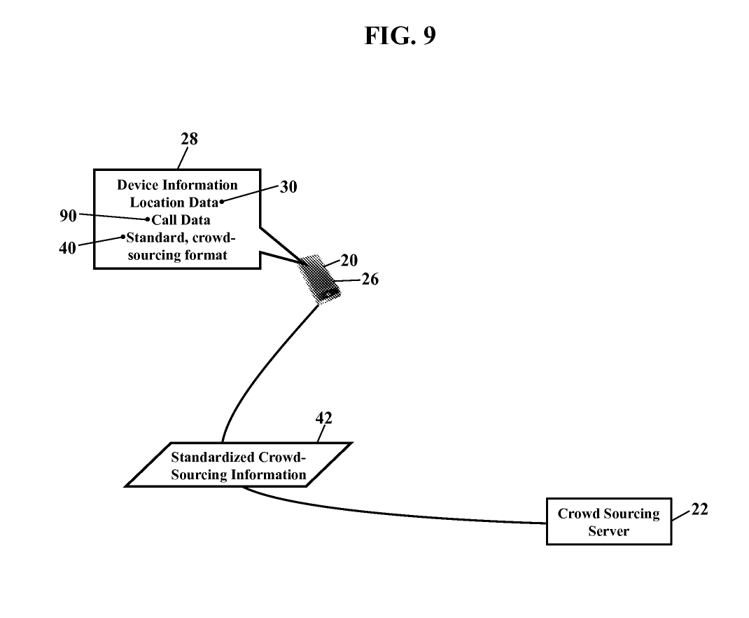

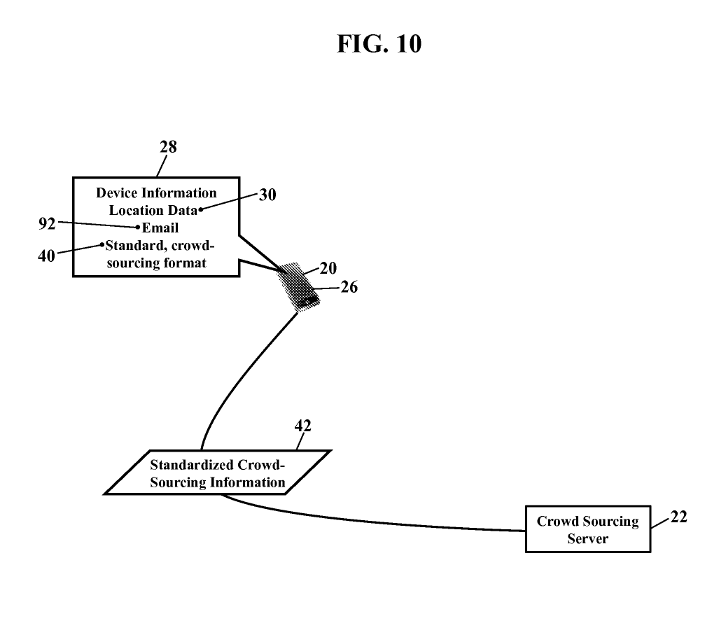

Exemplary embodiments may be applied to any multimedia file and/or format. FIG. 6, for example, illustrates a stored or received voicemail message 84. The mobile device 20 may translate the one or more of the user's voicemail messages 84 into the standard, crowd-sourcing format 40, which is then reported to the crowd-sourcing server 22. In FIG. 7, a digital image 86 captured or stored by the mobile device 20 is translated into the standard, crowd-sourcing format 40 and reported to the crowd-sourcing server 22. FIG. 8 illustrates translation of video data 88 into the standard, crowd sourcing format 40 for publication by the crowd-sourcing server 22. FIG. 9 illustrates translation of call data 90 (generated from a telephone or voice-over Internet Protocol call) into the standard, crowd sourcing format 40, which is reported to the crowd-sourcing server 22. FIG. 10 illustrates translation of email data 92 into the standard, crowd sourcing format 40 for reporting to the crowd-sourcing server 22. FIGS. 5-10 thus illustrate unified, open formatting of any file or data for multimedia crowd sourcing analytics.

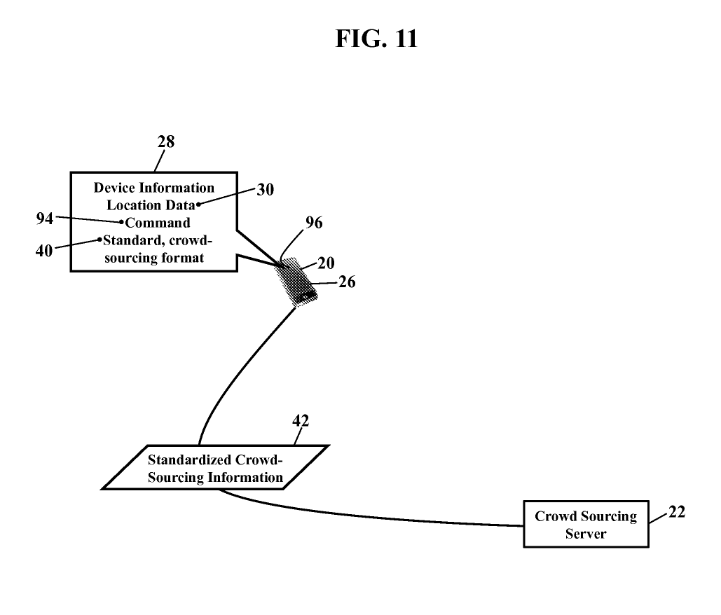

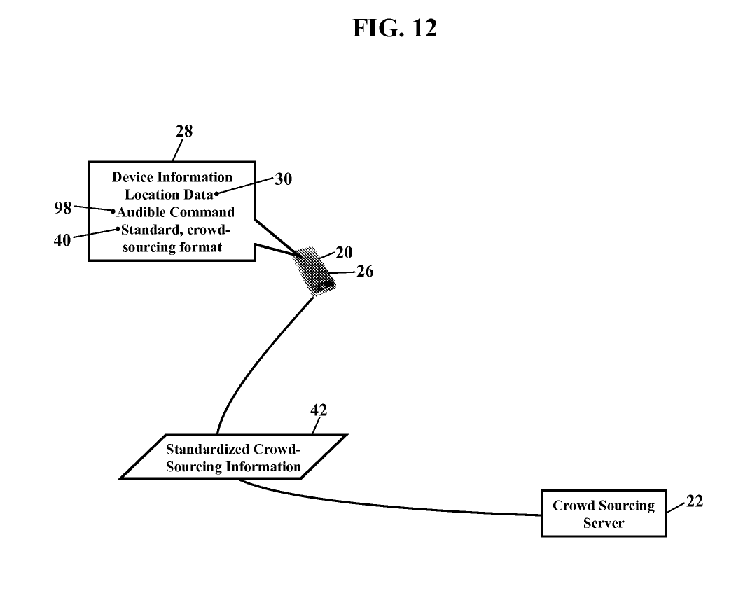

FIGS. 11-12 are schematics illustrating standardized commands, according to exemplary embodiments. Here the mobile device 20 may also standardize and report any command 94 input by the user of the mobile device 20. As the mobile device 20 is used, the user enters the command 94 on a user interface displayed on a display device 96. The user makes some graphical, manual selection to generate the command 94. FIG. 12 illustrates an audible command 98 that is spoken by the user and interpreted by the mobile device 20. Whatever the commands 94 and 98, the mobile device 20 performs the translation into the standard, crowd sourcing format 40. The mobile device 20 may then report the standardized crowd sourcing information 42 to the crowd-sourcing server 22.

Exemplary embodiments thus provide unified, unfragmented crowd sourced discovery solutions for vertical services. Whatever a user's spoken language, exemplary embodiments may translate spoken commands, voicemails, and videos into the standard, crowd sourcing format 40. Whatever the user's location, exemplary embodiments may translate any sensor data into the standard, crowd-sourcing format 40. Standardized information may then be reported to the crowd-sourcing server 22 for analytical and behavioral analysis. As an example, even though users in the same geographic location or zone may speak different languages, their spoken words may be translated into the standard, crowd-sourcing format 40 for traffic and environmental reporting. Exemplary embodiments automatically translate any verbal or sensory data into a standard set which may be used to influence crowd behavior. Exemplary embodiments thus describe a seamless, device sourcing solution with global values.

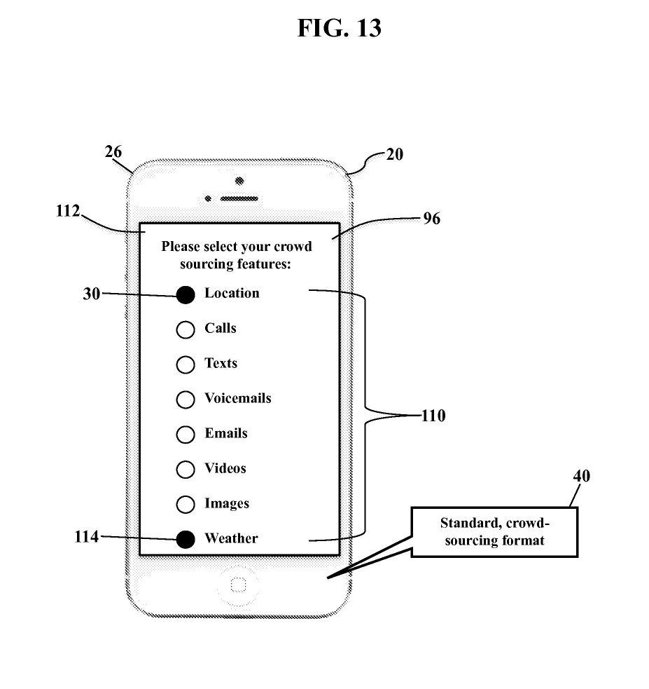

FIG. 13 is a schematic illustrating configuration settings 110, according to exemplary embodiments. FIG. 13 illustrates a user interface 112 displayed by the display device 96 of the user's mobile smart phone 26. The user interface 112 graphically presents the configuration settings 110 for crowd sourcing services. Some users may embrace crowd sourcing and want to participate in services that improve their experience and features. Other users, of course, may be cautious and not want their mobile device 20 automatically reporting to the crowd-sourcing server (described above as reference numeral 22). Some users, in other words, may wish to opt out of crowd sourcing analytics. Exemplary embodiments may thus have the configuration settings 110 for managing crowd sourcing services. As FIG. 13 illustrates, the user interface 112 may display the configuration settings 110 for turning on, or turning off, different reporting features. In FIG. 13, this particular user has agreed to standardize and share her location data 30 and weather data 114 (e.g., the temperature 70, pressure 72, and humidity 74 as illustrated in FIG. 4), but she has disabled crowd sourcing of her other multimedia options. The user interface 112 may thus present graphical controls that permit the user to move a cursor and select which information and/or data is standardized and reported. While FIG. 13 only presents a short list of the configuration settings 110, in practice the configuration settings 110 may be as lengthy and complete as desired. Whichever configuration setting 110 is enabled, the corresponding information and an associated time stamp may be translated into the standard, crowd-sourcing format 40 for high-speed processing and faster analytics findings. Exemplary embodiments may thus automatically report and be independent of repeated manual reporting. The user thus consents to whatever crowd sourcing information is shared. For example, should the user agree to share her GPS location data 30, exemplary embodiments may automatically activate the GPS capability on the mobile device 20. Indeed, as enabled data is automatically standardized and reported, data is acquired with minimal risk to the user (such as during driving or exercise).

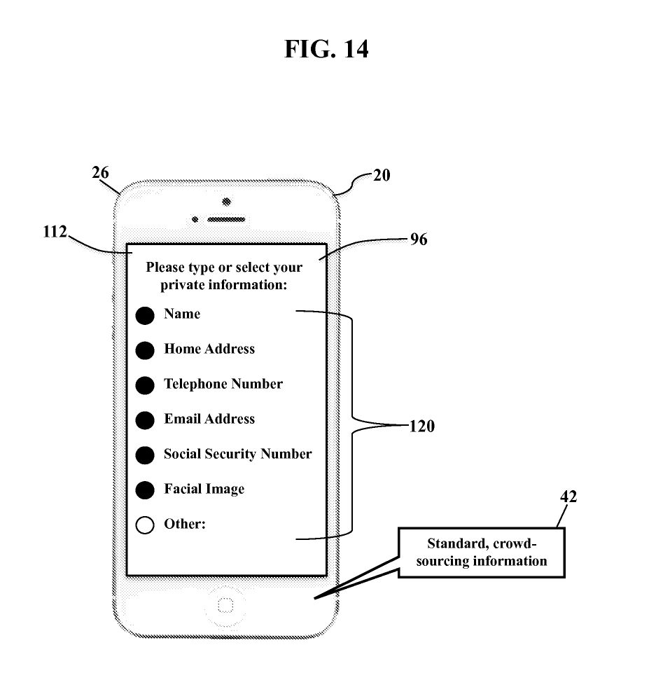

FIG. 14 is a schematic illustrating anonymous reporting for crowd sourcing analytics, according to exemplary embodiments. Here the user may define or select private information 120 that is never revealed. Even though the user may opt in for crowd sourcing services, the user may wish that her standardized, crowd sourcing information 42 remains anonymous. That is, even though the user may appreciate the benefit of crowd sourcing analytics, she may not want to reveal her name, age, social security number, and any other private information 120. Exemplary embodiments, then, may render her standardized, crowd sourcing information 42 anonymous prior to reporting to the crowd-sourcing server (described above as reference numeral 22). Exemplary embodiments, for example, may compare her standardized, crowd sourcing information 42 to a table or listing of the private information 120 that is never revealed. Should any of the standardized, crowd sourcing information 42 match the private information 120, that private information 120 may be removed, deleted, or redacted prior to publication. The mobile device 20 may anonymize the standardized, crowd sourcing information 42 prior to reporting, or the crowd-sourcing server 22 may anonymize after receipt but prior to publication. Regardless, the user's private information 120 is not revealed.

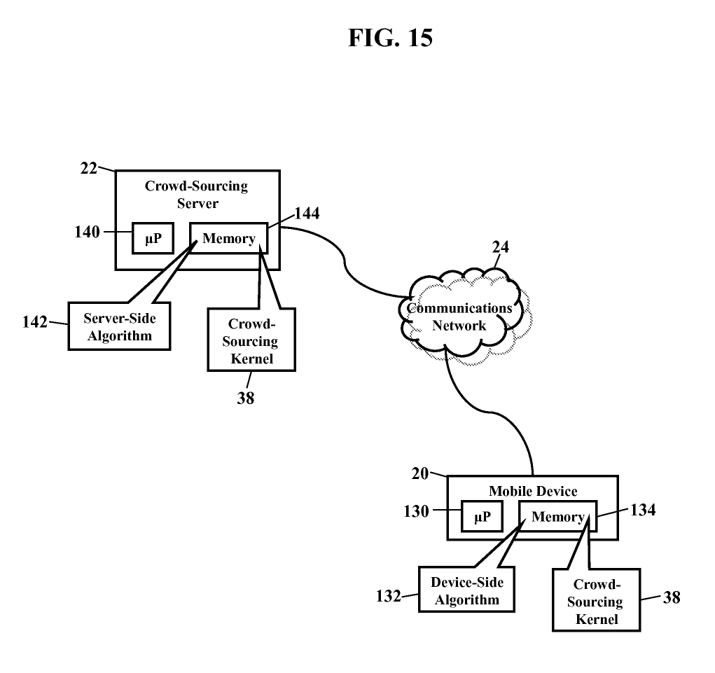

FIG. 15 is a more detailed schematic illustrating the operating environment, according to exemplary embodiments. The mobile device 20 may have a processor 130 (e.g., “μP”), application specific integrated circuit (ASIC), or other component that executes a device-side algorithm 132 stored in a local memory 134. When the device-side algorithm 132 needs any crowd-sourcing service, data, or feature, the device-side algorithm 132 may call or invoke the crowd-sourcing kernel 38. The crowd-sourcing server 22 may also have a processor 140 (e.g., “μP”), application specific integrated circuit (ASIC), or other component that executes a server-side algorithm 142 stored in a local memory 144. The server-side algorithm 142 may also use the crowd-sourcing kernel 38 for crowd-sourcing services, data, or features. The device-side algorithm 132 and the server-side algorithm 56 may thus include instructions, code, and/or programs that cooperate in a server-client relationship, via the communications network 24, to standardize and report any data.

Exemplary embodiments may be applied regardless of networking environment. As the above paragraphs mentioned, the communications network 24 may be a wireless network having cellular, WI-FI®, and/or BLUETOOTH® capability. The communications network 24, however, may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the IEEE 802 family of standards, GSM/CDMA/TDMA or any cellular standard, and/or the ISM band). The communications network 24 may even include power line portions, in which signals are communicated via electrical wiring. The concepts described herein may be applied to any wireless/wireline communications network, regardless of physical componentry, physical configuration, or communications standard(s).

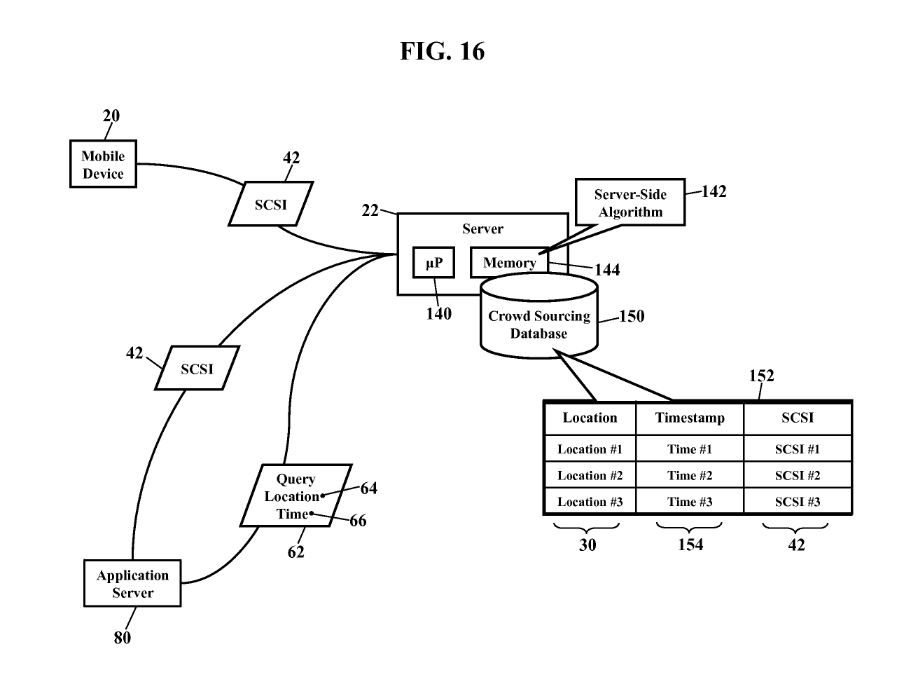

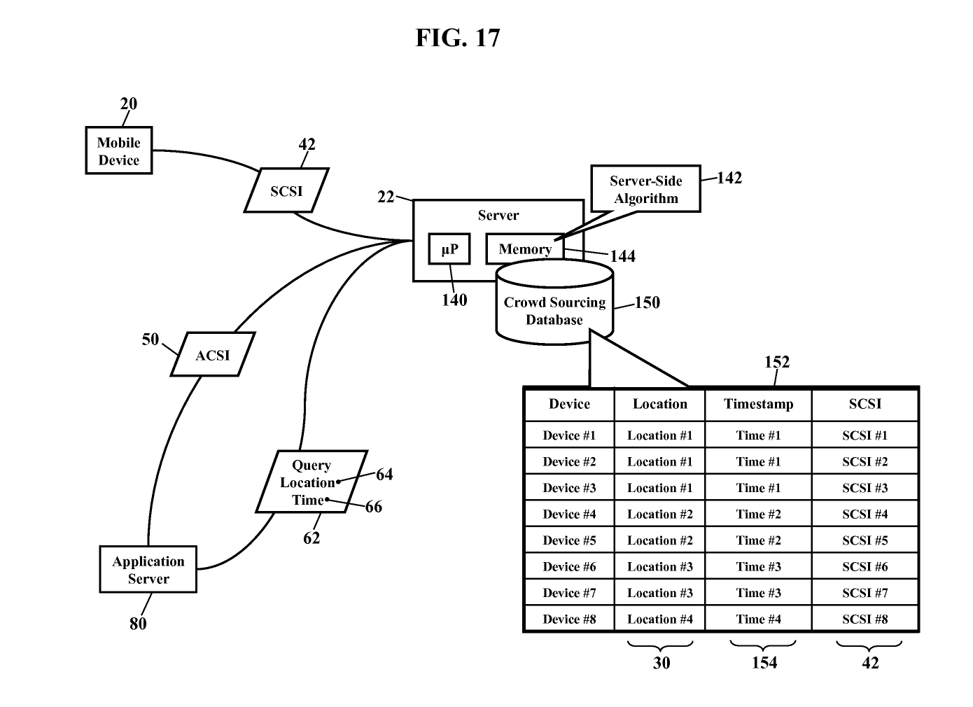

FIGS. 16-17 are diagrams illustrating a crowd sourcing database 150, according to exemplary embodiments. As this disclosure explains, the mobile device 20 collects and reports its standardized crowd sourcing information (“SCSI”) 42 to the crowd-sourcing server 22. The crowd-sourcing server 22 stores the standardized crowd sourcing information 42 in the crowd sourcing database 150. FIG. 16 illustrates the crowd sourcing database 150 locally stored in the memory 144 of the crowd-sourcing server 22, but the crowd sourcing database 150 may be remotely maintained and accessed. Regardless, the crowd sourcing database 150 is illustrated as a table 152 that maps, relates, or associates the standardized crowd sourcing information (“SCSI”) 42 to its corresponding location data 30 and to its corresponding time stamp 154. Each entry in the crowd sourcing database 150 may thus be populated with an individual, micro-report from a single mobile device 20. When the crowd-sourcing server 22 receives the query 62 (from any application server 154, such as the traffic analysis server 60 illustrated in FIG. 3 and the weather analysis server 80 in FIG. 4), the server-side algorithm 142 may query the crowd sourcing database 150 for the query parameter (such as the query location 64 and/or the time 66). If the query parameter matches an entry in the crowd sourcing database 150, the server-side algorithm 142 retrieves the corresponding standardized crowd sourcing information 42. The server-side algorithm 142 then causes the crowd-sourcing server 22 to send the corresponding standardized crowd sourcing information 42 as a response to the query 62.

FIG. 17 illustrates the aggregated crowd sourcing information (or “ACSI”) 50. As the crowd-sourcing server 22 may store reports from hundreds, thousands, or even millions of mobile devices 20, the crowd-sourcing server 22 may retrieve and combine some or all of the standardized crowd sourcing information (“SCSI”) 42 that is commonly associated with the query parameter (such as the query location 64 and/or the time 66). Indeed, in metropolitan areas, many mobile devices 20 may contemporaneously report for nearly the same geographic location 30 and/or the timestamp 154. So, when the crowd-sourcing server 22 receives the query 62, the server-side algorithm 142 may query for and retrieve some or all of the entries matching the query parameter. The server-side algorithm 142 may sum, tally, and/or combine all the matching entries into the aggregated crowd sourcing information 50. The crowd sourcing server 22 thus responds with the aggregated crowd sourcing information 50.

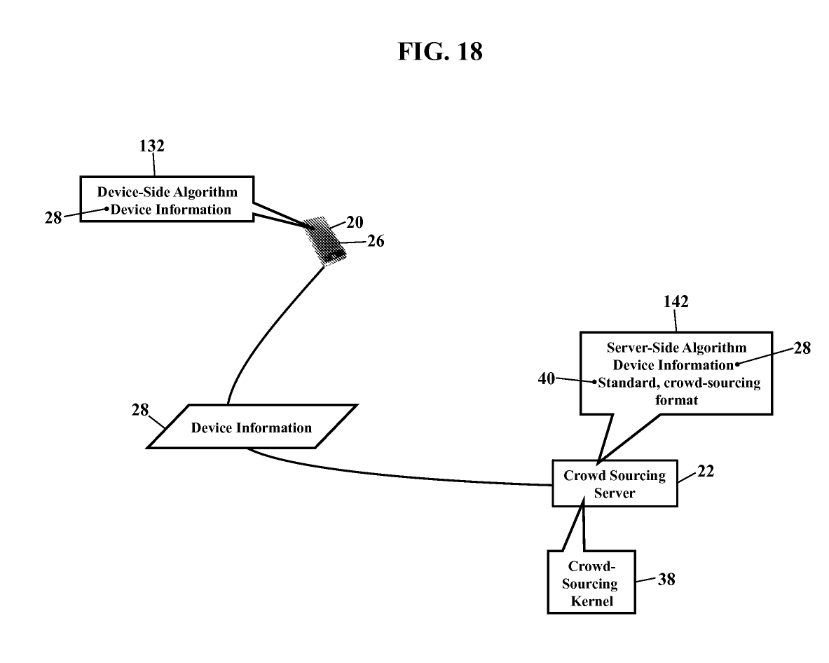

FIG. 18 is a diagram illustrating centralized standardization, according to exemplary embodiments. Here the mobile device 20 may report its raw device information 28 to the crowd-sourcing server 22. The device-side algorithm 132 may cause the mobile device 20 to send the device information 28 to the network address of the crowd-sourcing server 22. When the crowd-sourcing server 22 receives the device information 28, the server-side algorithm 142 and the crowd-sourcing kernel 38 may cooperate to translate the device information 28 into the standard, crowd sourcing format 40. The crowd-sourcing server 22 then makes the standardized crowd sourcing information 42 available for crowd sourcing analytics. Indeed, many mobile devices 20 may report their respective device information 28 to the crowd-sourcing server 22, which is standardized and aggregated into the aggregated crowd sourcing information 50. Exemplary embodiments thus include centralized standardization.

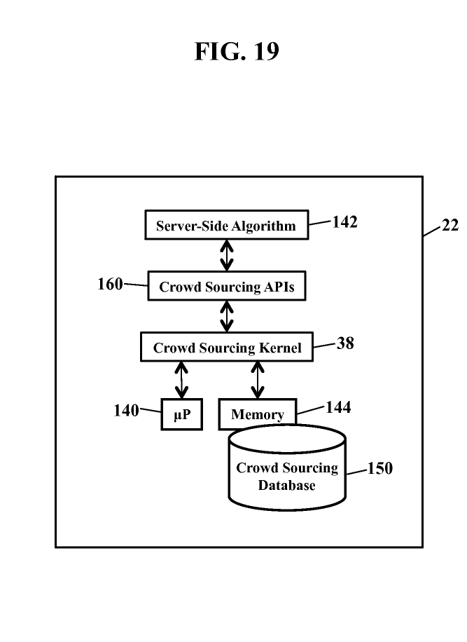

FIG. 19 is a more detailed block diagram illustrating the operating environment, according to exemplary embodiments. FIG. 19 illustrates the crowd sourcing server 22 storing and executing the crowd-sourcing kernel 38 and the server-side algorithm 142. When crowd sourcing services are needed, the server-side algorithm 142 uses common crowd sourcing application programming interfaces (“APIs”) 160. The crowd sourcing kernel 38 interprets the crowd sourcing application programming interfaces 160, events, and/or triggers that are used for crowd sourcing analytics.

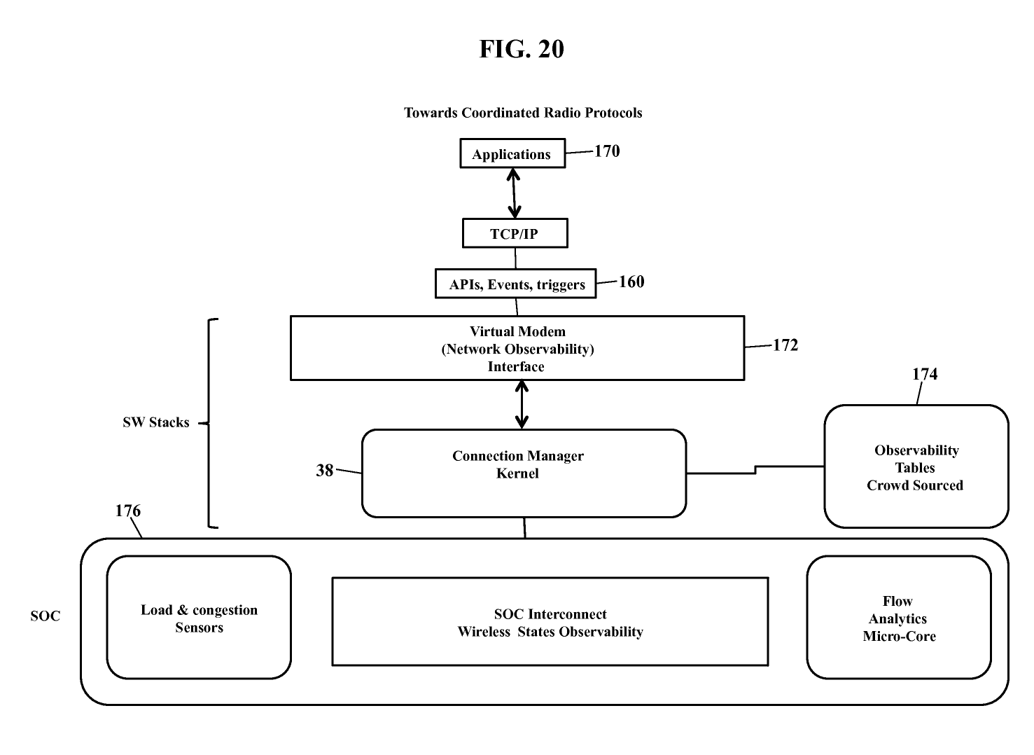

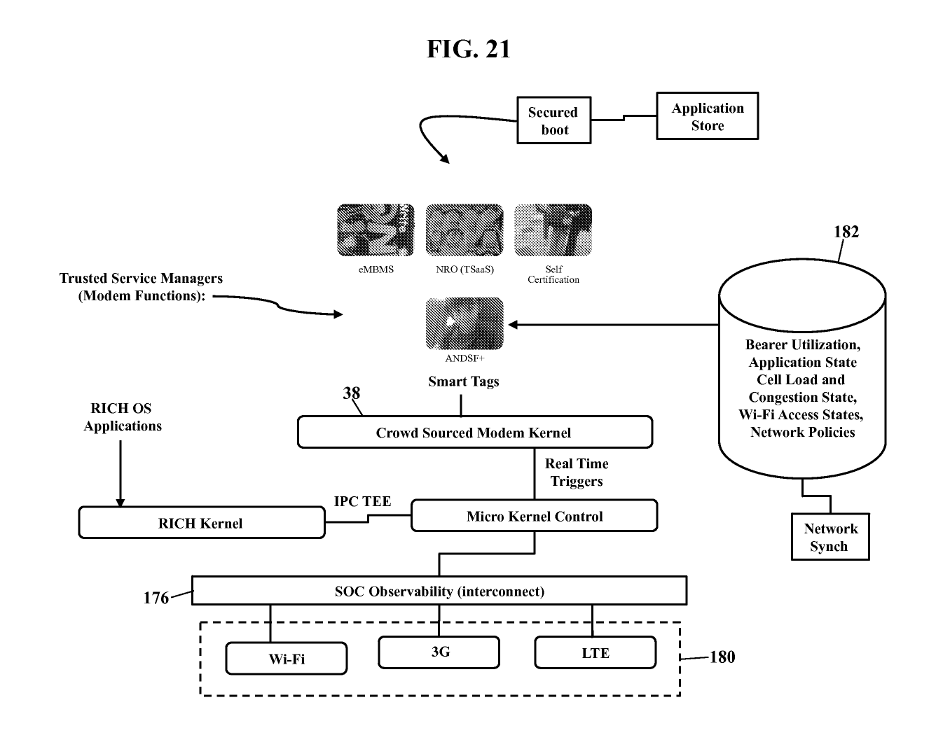

FIGS. 20-21 are detailed block diagram illustrating crowd-sourcing control of radio networks, according to exemplary embodiments. Here, exemplary embodiments may use crowd sourcing to analyze congestion in radio networks. Whatever application (Block 170) needs crowd sourcing services, the common crowd sourcing application programming interfaces (“APIs”) 160 are used to interpret triggers, events, and other calls. A virtual modem (Block 172) and the crowd sourcing kernel (Block 38) may cooperate in a software stack as an interface to observe crowd sourced observability tables (Block 174) for the radio networks. The crowd sourcing kernel (Block 38) also interfaces with a system-on-chip (Block 176) having sensors for measuring or inferring load and congestion, observing interconnection wireless states, and flow analytics.

FIG. 21 illustrates modem functionalities. Here the crowd sourcing kernel (Block 38) provides modem calls and functions for interconnections to wireless radio networks (Block 180). The crowd sourcing kernel (Block 38) interfaces with the system-on-chip (Block 176) to observe the interconnection wireless states. The crowd sourcing kernel (Block 38) may also interface with any number of observability databases (Block 182).

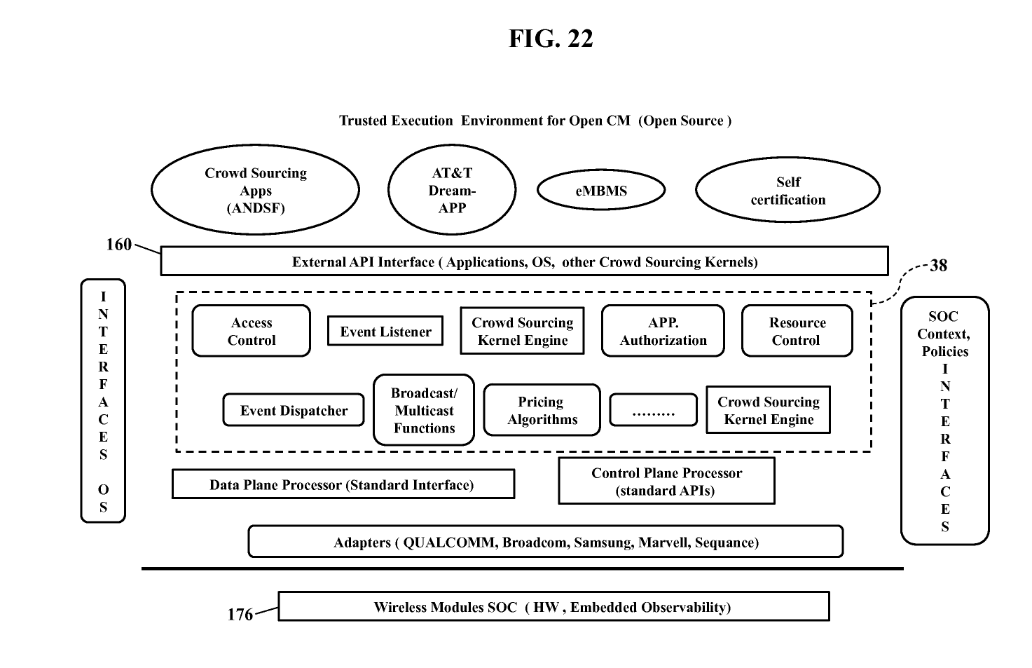

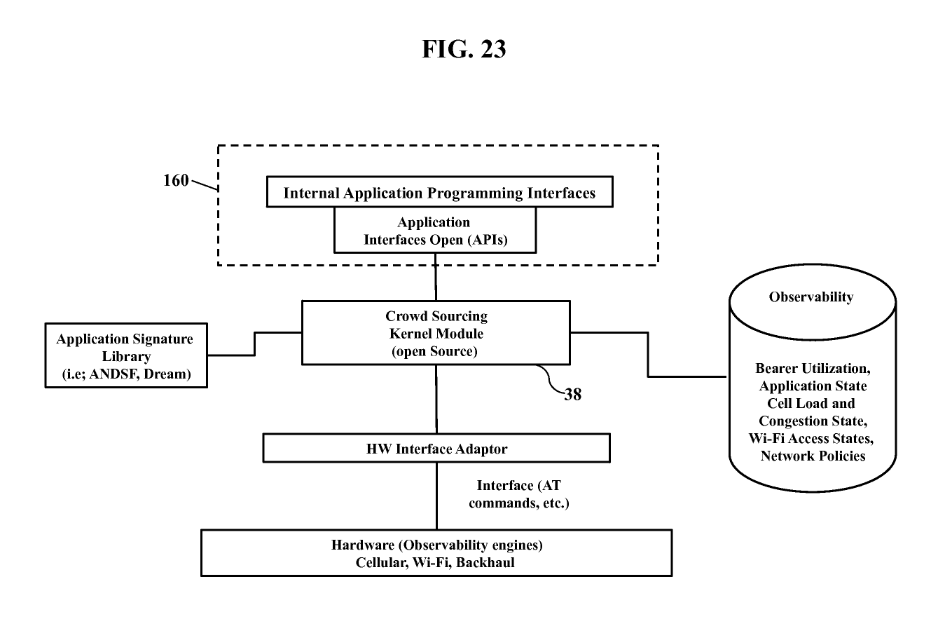

FIGS. 22-23 are block diagrams further illustrating the crowd sourcing kernel (Block 38), according to exemplary embodiments. Here the crowd sourcing kernel 38 may operate in an open source environment with many interfaces to hardware and software. FIG. 22, for example, illustrates the crowd sourcing kernel 38 having an interface to an operating system and an interface to the system-on-chip (Block 176). The crowd sourcing kernel 38 has the common crowd sourcing application programming interfaces (“APIs”) (Block 160) that are unique to crowd sourcing services. FIG. 23 further illustrates the open application programming interfaces (Block 160) that are used to interface with any hardware. Whatever the connection, and whenever a crowd sourcing service or feature is needed, the crowd sourcing kernel (Block 38) is called to manage and interpret any input/output request.

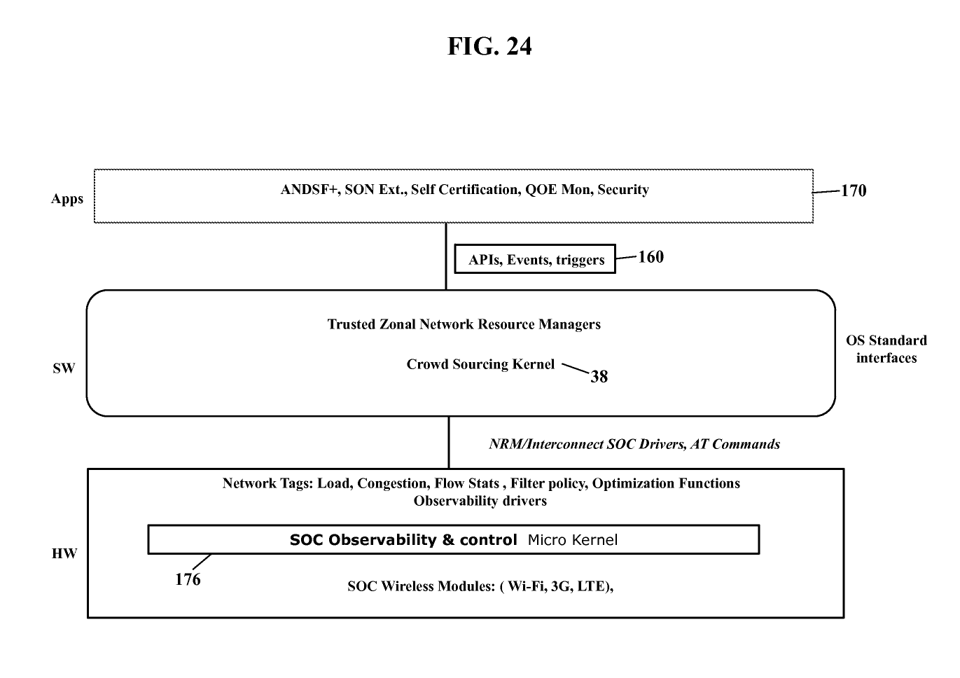

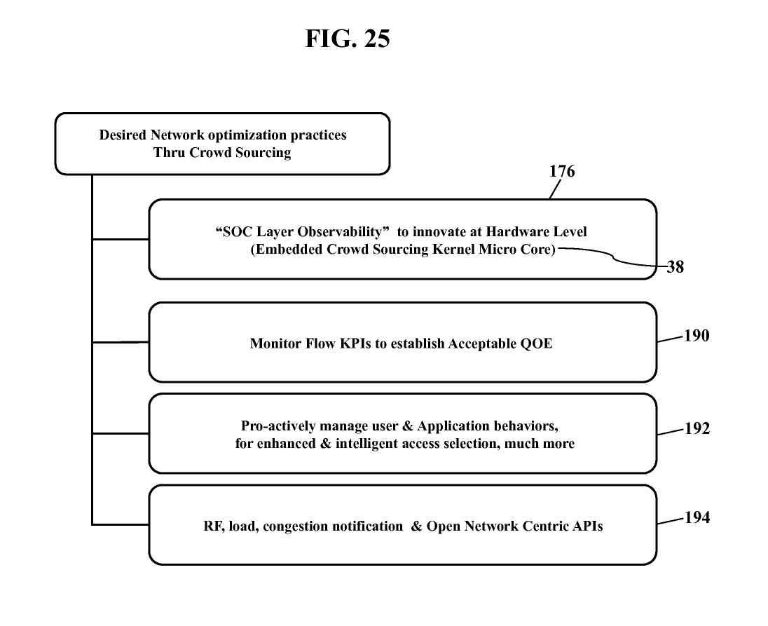

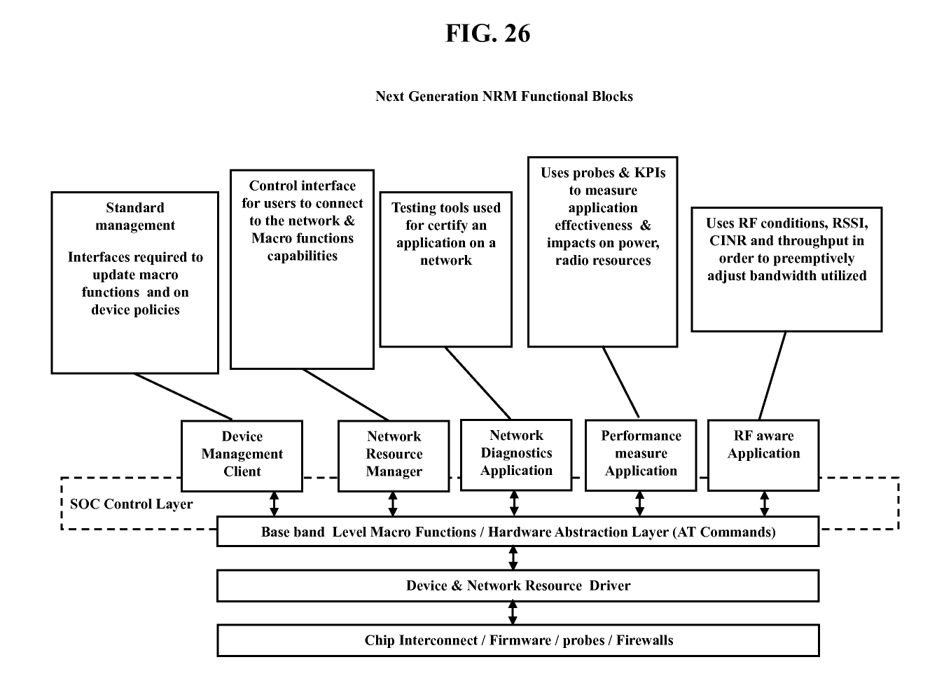

FIGS. 24-26 are block diagrams illustrating network resource management (or “NRM”), according to exemplary embodiments. As FIG. 24 illustrates, exemplary embodiments may use crowd sourcing to manage network resources. For example, whatever the application (Block 170), the common crowd sourcing application programming interfaces (Block 160) may be used to call the functions provided by the crowd sourcing kernel 38. The crowd sourcing kernel 38 interprets the application programming interfaces 160 and, in turn, manages input/output to hardware (such as the system-on-chip 176). FIG. 25 illustrates network optimization using crowd sourcing. The crowd sourcing kernel 38, for example, may be embedded on the system-on-chip (Block 176) to observe various performance parameters and to monitor data flows for acceptable quality (Block 190). The crowd sourcing kernel 38 may also manage crowd-sourcing behaviors (Block 192) to notify of load, congestion, and other network conditions (Block 194). FIG. 26 illustrates functional blocks for using crowd sourcing to manage communications networks. All these features may be used to proactively manage network resources, using crowd sourcing behaviors.

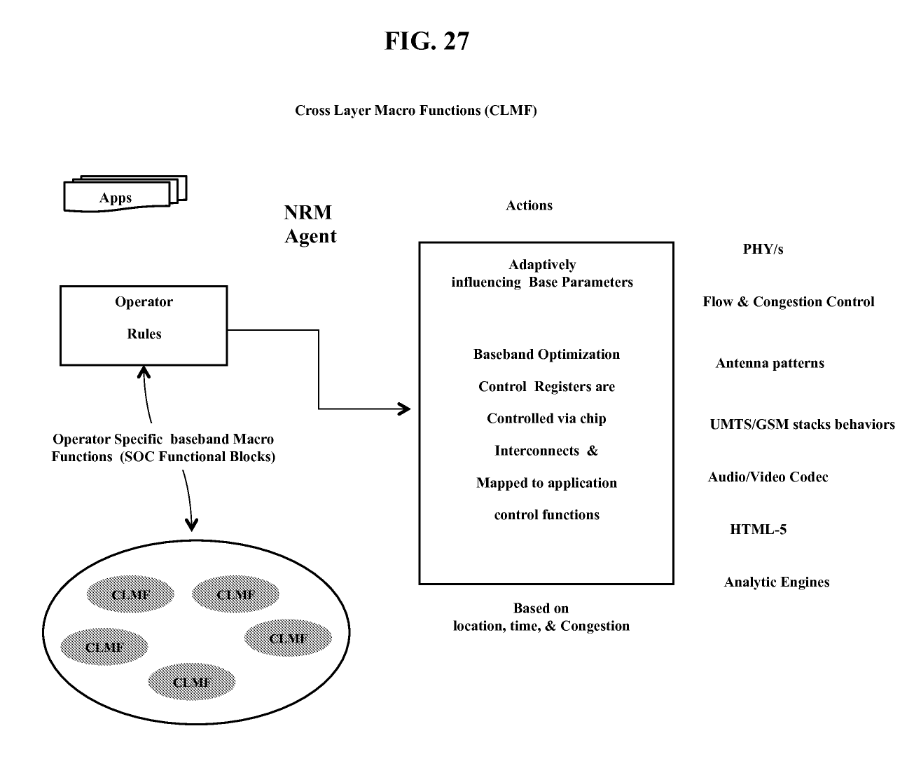

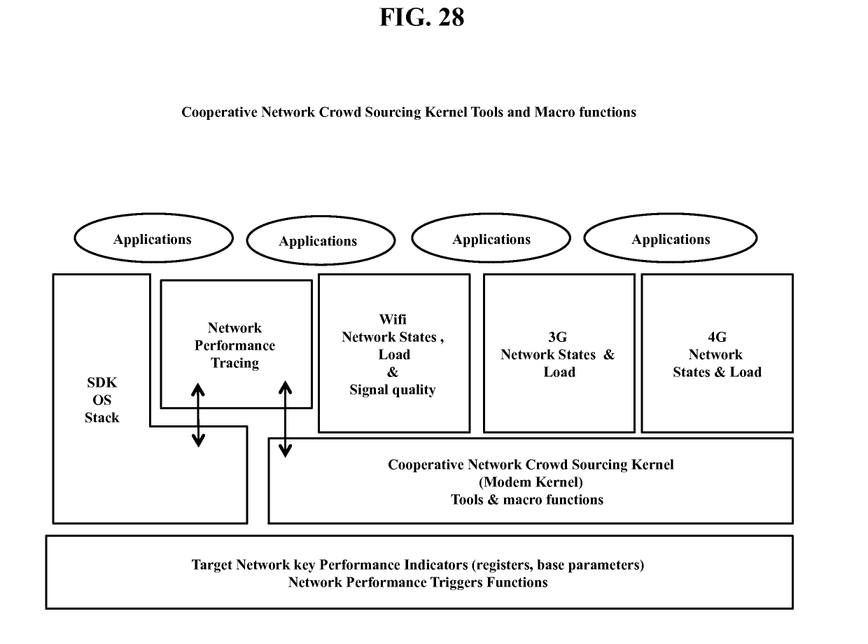

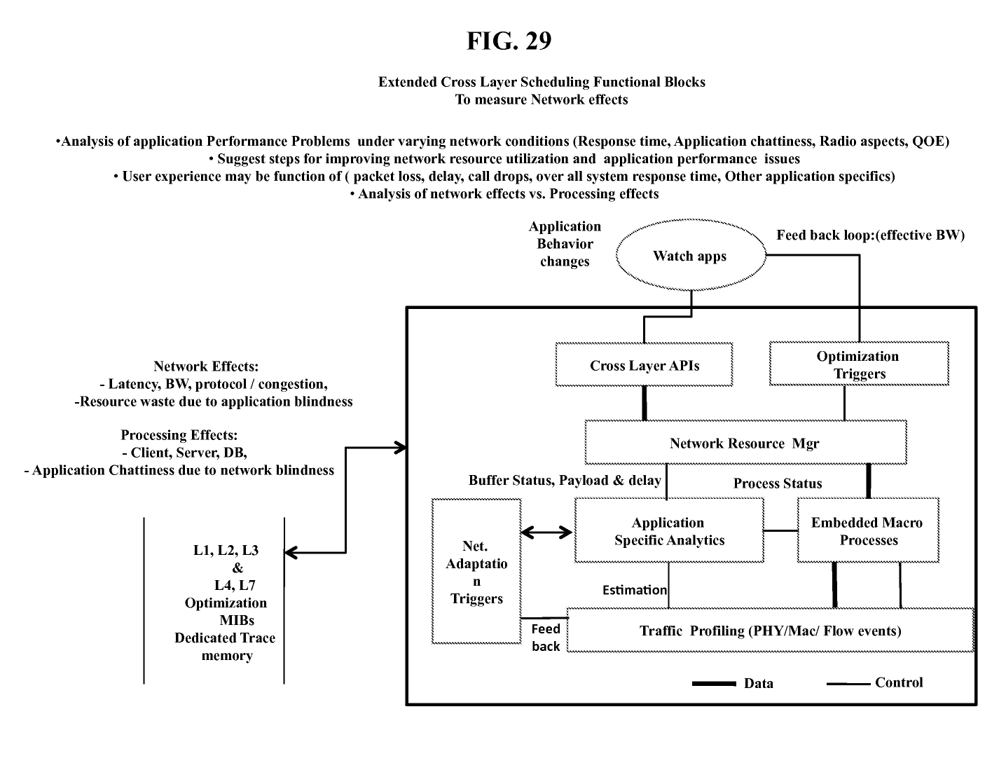

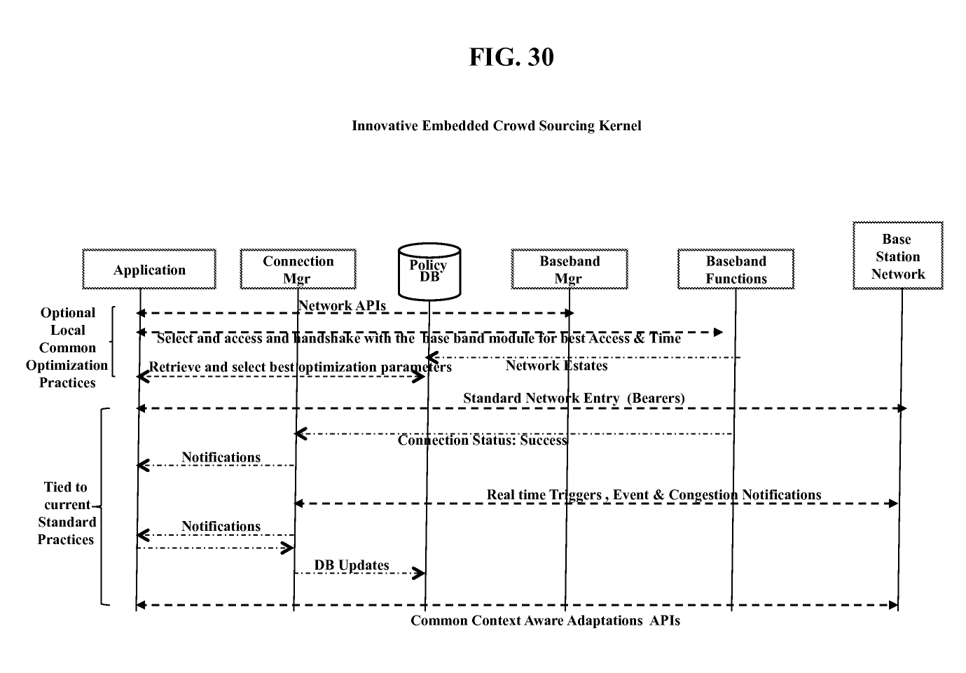

FIGS. 27-30 are more block diagrams illustrating crowd-sourced control of communications networks, according to exemplary embodiments. As client, mobile devices report their standardized information, exemplary embodiments may use their collective device information as crowd sourcing management of communications networks.

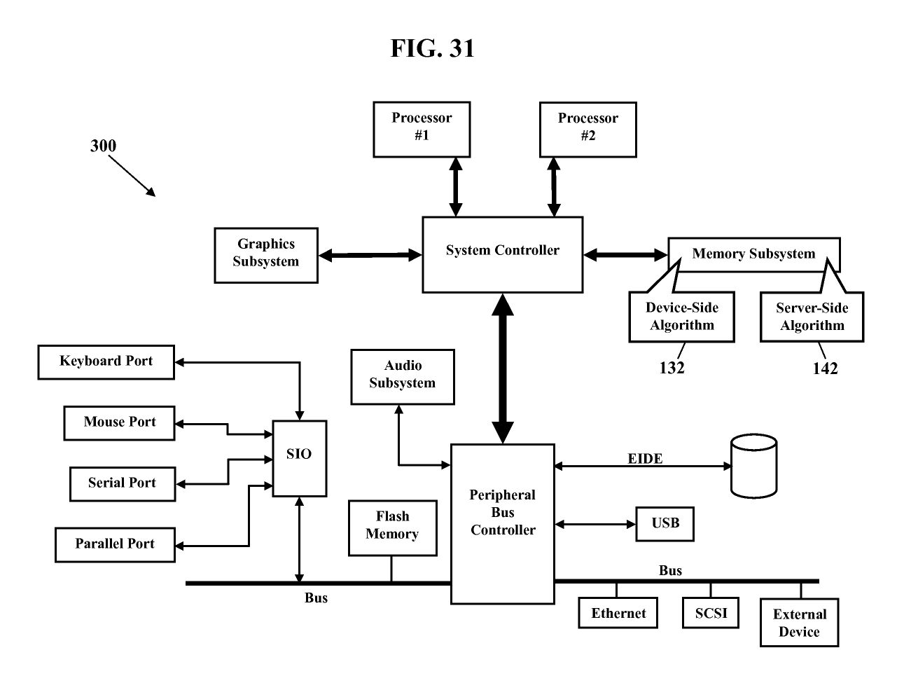

FIG. 31 is a schematic illustrating still more exemplary embodiments. FIG. 31 is a more detailed diagram illustrating a processor-controlled device 300. As earlier paragraphs explained, the server-side algorithm 142 and the device-side algorithm 132 may operate in any processor-controlled device. FIG. 31, then, illustrates the device-side algorithm 132 and the server-side algorithm 142 stored in a memory subsystem of the processor-controlled device 300. One or more processors communicate with the memory subsystem and execute either, some, or all applications. Because the processor-controlled device 300 is well known to those of ordinary skill in the art, no further explanation is needed.

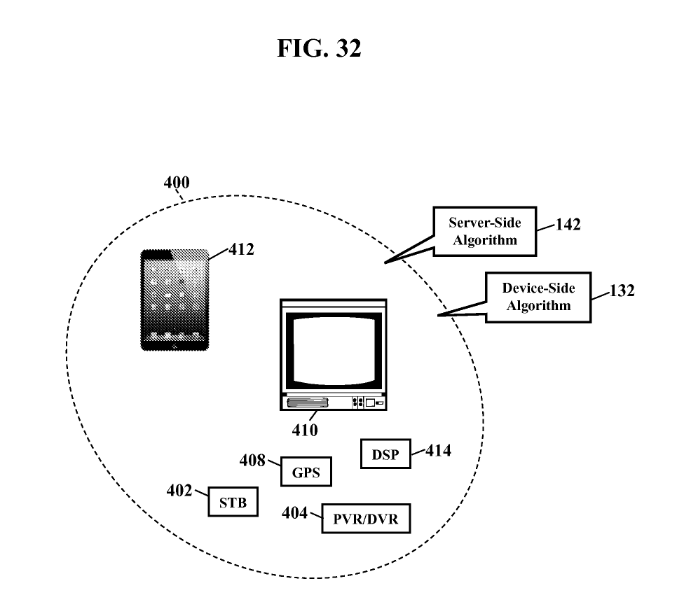

FIG. 32 depicts other possible operating environments for additional aspects of the exemplary embodiments. FIG. 32 illustrates the device-side algorithm 132 and the server-side algorithm 142 operating within various other devices 400. FIG. 32, for example, illustrates that the device-side algorithm 132 and the server-side algorithm 142 may entirely or partially operate within a set-top box (“STB”) (402), a personal/digital video recorder (PVR/DVR) 404, a Global Positioning System (GPS) device 408, an interactive television 410, a tablet computer 412, or any computer system, communications device, or processor-controlled device utilizing the processor 50 and/or a digital signal processor (DP/DSP) 414. The device 400 may also include network switches, routers, modems, watches, radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for standardized crowd sourcing, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
receiving device information at a mobile device;
translating the device information into a standard crowd sourcing format to generate standardized crowd sourcing information; and
reporting the standardized crowd sourcing information from the mobile device over a communications network to a central crowd-sourcing server for crowd sourcing analytics.

2. The method of claim 1, further comprising calling a crowd sourcing kernel that manages a crowd sourcing service requested of a processor in the mobile device.

3. The method of claim 2, further comprising using a crowd sourcing interface that is unique to the crowd sourcing service.

4. The method of claim 1, further comprising anonymizing the standardized crowd sourcing information.

5. The method of claim 1, further comprising translating weather data into the standard crowd sourcing format.

6. The method of claim 1, further comprising time stamping the standardized crowd sourcing information.

7. The method of claim 1, further comprising reporting location data with the standardized crowd sourcing information.

8. A system, comprising:
a processor; and
memory storing instructions that when executed cause the processor to perform operations, the operations comprising:
receiving standardized crowd sourcing information that has been translated by a mobile device into a standard crowd sourcing format;
storing the standardized crowd sourcing information as an entry in a central database that stores other standardized crowd sourcing information reported by other mobile devices; and
associating the standardized crowd sourcing information in the central database to location data of the mobile device.

9. The system of claim 8, wherein the operations further comprise receiving a query specifying a location.

10. The system of claim 9, wherein the operations further comprise querying the central database for the location.

11. The system of claim 10, wherein the operations further comprise retrieving the standardized crowd sourcing information that matches the location.

12. The system of claim 11, wherein the operations further comprise:
aggregating the standardized crowd sourcing information with the other standardized crowd sourcing information that also matches the location reported by the other mobile devices; and
generating aggregated crowd sourcing information that is commonly translated into the standard crowd sourcing format.

13. The system of claim 12, wherein the operations further comprise sending a query response that includes the aggregated crowd sourcing information for multiple mobile devices.

14. The system of claim 8, wherein the operations further comprise anonymizing the standardized crowd sourcing information.

15. A memory storing instructions that when execute cause a processor to perform operations, the operations comprising:
receiving device information;
translating the device information into a standard crowd sourcing format to generate standardized crowd sourcing information; and
reporting the standardized crowd sourcing information over a communications network to a central crowd-sourcing server for crowd sourcing analytics.

16. The memory of claim 15, wherein the operations further comprise calling a crowd sourcing kernel that manages a crowd sourcing service requested of the processor.

17. The memory of claim 16, wherein the operations further comprise using a crowd sourcing interface that is unique to the crowd sourcing service.

18. The memory of claim 15, wherein the operations further comprise anonymizing the standardized crowd sourcing information.

19. The memory of claim 15, wherein the operations further comprise translating weather data into the standard crowd sourcing format.

20. The memory of claim 15, wherein the operations further comprise time stamping the standardized crowd sourcing information.
